(19) United States
(12) Patent Application Publication
(10) Pub. No.: US 2024/0428429 A1
(43) Pub. Date: Dec. 26, 2024

(54) SIDE BRANCH DETECTION FOR INTRAVASCULAR IMAGE CO-REGISTRATION WITH EXTRAVASCULAR IMAGES

(71) Applicant: Boston Scientific Scimed Inc., Maple Grove, MN (US)

(72) Inventors: Qian Li, Saratoga, CA (US); Hatice Cinar Akakin, Eden Prairie, MN (US); Alexander Shang, Minneapolis, MN (US); Wenguang Li, Los Gatos, CA (US)

(73) Assignee: Boston Scientific Scimed Inc., Maple Grove, MN (US)

(21) Appl. No.: 18/667,561

(22) Filed: May 17, 2024

Related U.S. Application Data
(60) Provisional application No. 63/503,105, filed on May 18, 2023.

(51) Int. Cl. G06T 7/33; G06T 7/73; G06V 10/82

(52) U.S. Cl. CPC G06T 7/33; G06T 7/73; G06V 10/82; G06T 2207/10132; G06T 2207/20081; G06T 2207/20084; G06T 2207/30101; G06V 2201/03

(57) ABSTRACT

The present disclosure provides devices and methods to identify locations of side branches in a series of intravascular images (e.g., a pre-treatment IVUS pullback, a post-treatment IVUS pullback, or the like) to assist with co-registering the IVUS images with an extravascular image (e.g., angiogram, or the like) or with another set of IVUS images. The present disclosure further provides devices and methods for training a machine learning (ML) model to infer side branch locations from IVUS images and an analytic algorithm for extracting frames from the IVUS images representing side branches.

### CROSS-REFERENCE TO RELATED APPLICATIONS

This application claims the benefit of U.S. Provisional Patent Application Ser. No. 63/503,105 filed on May 18, 2023, the disclosure of which is incorporated herein by reference.

### TECHNICAL FIELD

The present disclosure generally relates to intravascular ultrasound (IVUS) imaging systems. Particularly, but not exclusively, the present disclosure relates to identifying side branches in a series of intravascular images to assist with co-registering the intravascular images with an extravascular image or registering multiple sets of intravascular images of the same vessel.

### BACKGROUND

Ultrasound devices insertable into patients have proven diagnostic capabilities for a variety of diseases and disorders. For example, intravascular ultrasound (IVUS) imaging systems have been used as an imaging modality for diagnosing blocked blood vessels and providing information to aid medical practitioners in selecting and placing stents, selecting sites for an atherectomy procedure, or the like.

IVUS imaging systems includes a control module (with a pulse generator, an image acquisition and processing components, and a monitor), a catheter, and a transducer disposed in the catheter. The transducer-containing catheter is positioned in a lumen or cavity within, or in proximity to, a region to be imaged, such as a blood vessel wall or patient tissue in proximity to a blood vessel wall. The pulse generator in the control module generates electrical pulses that are delivered to the transducer and transformed to acoustic pulses that are transmitted through patient tissue. The patient tissue (or other structure) reflects the acoustic pulses and reflected pulses are absorbed by the transducer and transformed to electric pulses. The transformed electric pulses are delivered to the image acquisition and processing components and converted into images displayable on the monitor.

However, it can be difficult for physicians to correlate IVUS images with other external imaging of the vessel to be treated. For example, it is difficult to correlate the overall structure of the vessel depicted in an angiogram with the structure of the same vessel depicted in IVUS images. Further, it can be difficult to correlate multiple sets of IVUS images of the same vessel. For example, it can be difficult to correlate a pre-treatment IVUS run with a post-treatment IVUS run.

Thus, there is a need for systems and methods that enable co-registration of external images with IVUS images or of IVUS images with another set of IVUS images.

### BRIEF SUMMARY

This Summary is provided to introduce a selection of concepts in a simplified form that are further described below in the Detailed Description. This Summary is not intended to necessarily identify key features or essential features of the claimed subject matter, nor is it intended as an aid in determining the scope of the claimed subject matter.

In general, the present disclosure provides to identify locations of side branches in a series of intravascular images (e.g., a pre-treatment IVUS pullback, a post-treatment IVUS pullback, or the like) to assist with co-registering the IVUS images with an extravascular image (e.g., angiogram, or the like) or with another set of IVUS images. The present disclosure provides for training a machine learning (ML) model to infer side branch locations from IVUS images and an analytic algorithm for extracting frames from the IVUS images representing side branches.

In some embodiments, the disclosure can be implemented as a method. The method can comprise receiving, at a processor, a series of intravascular ultrasound (IVUS) images of a vessel of a patient, the series of IVUS images comprising a plurality of image frames; identifying, by the processor via a first machine learning (ML) model, a set of frames of the plurality of image frames, wherein the frames of the set of frame are associated with one or more side branches of the vessel; identifying, by the processor via a second ML model, a location of at least one of the one or more side branches in one or more frames of the plurality of image frames; and selecting, by the processor, a subset of frames from the set of frames based in part on output from the first ML model and output from the second ML model.

With some embodiments of the method, the first ML model is trained to infer the set of frames from the plurality of image frames.

With some embodiments of the method, the first ML model is configured to receive as input one or more adjacent frames from the plurality of image frames.

With some embodiments of the method, the first ML model is a convolutional neural network (CNN), a vision transformer network, or a combination of CNN and vision transformer networks.

With some embodiments of the method, the first ML model is configured apply a convolution window over a single frame or multiple adjacent frames from the plurality of image frames until all frames of the plurality of image frames have been received as input.

With some embodiments of the method, the second ML model is trained to determine, for each frame of the plurality of image frames, whether the frame represents a side branch of the one or more side branches; and identify, for each frame determined to represent the side branch of the one or more side branches, the location in the frame of the side branch of the one or more side branches.

With some embodiments of the method, the first ML model is configured to output, for each frame of the set of frames, a confidence score representing a confidence in the detection of the one or more side branches in the frame and wherein selecting a subset of frames from the set of frames comprises identifying frames from the set of frames with a confidence score greater than or equal to a threshold level; and selecting the identified frames for inclusion in the subset of frames.

With some embodiments of the method, the second ML model is trained to generate an indication of the location as a bounding box.

With some embodiments of the method, selecting frames from the ones of the set of frames of the series of IVUS images comprises identifying adjacent frames from the plurality of image frames where the bounding boxes in each frame are within a threshold distance from each other; and merging the side branches associated with the identified frames.

With some embodiments of the method, the first ML model is configured to output, for each frame of the set of frames, a confidence score representing a confidence in the detection of the one or more side branches in the frame and wherein merging the side branches associated with the identified adjacent frames comprises identifying the one of the adjacent frames, with the highest confidence score, from the set of frames where the bounding boxes are within a threshold distance of each other; and selecting the identified one of the adjacent frames with the highest confidence score as the frame from the plurality of image frames for inclusion in the subset of frames.

With some embodiments of the method, the second ML model is a convolutional neural network (CNN).

With some embodiments of the method, the second ML model is a vision transformer network.

With some embodiments of the method, the second ML model is a combination of CNN and vision transformer networks.

In some embodiments, the disclosure can be implemented as an apparatus for an intravascular imaging device. The apparatus can comprise a processor; and a memory comprising instructions that in response to being executed by the processor cause the apparatus to implement the method of any of the embodiments described herein.

In some embodiments, the disclosure can be implemented as at least one machine readable storage device, comprising a plurality of instructions that in response to being executed by a processor of an intravascular ultrasound (IVUS) imaging system cause the processor to implement the method of any of the embodiments described herein.

In some embodiments, the disclosure can be implemented as an apparatus for intravascular imaging device. The apparatus can comprise a processor; and a memory comprising instructions that in response to being executed by the processor cause the apparatus to receive a series of intravascular ultrasound (IVUS) images of a vessel of a patient, the series of IVUS images comprising a plurality of image frames; identify, via a first machine learning (ML) model, a set of frames of the plurality of image frames, wherein the frames of the set of frames are associated with one or more side branches of the vessel; identify, via a second ML model, a location of at least one of the one or more side branches in one or more frames of the plurality of image frames; select a subset of frames from the set of frames based in part on output from the first ML model and output from the second ML model.

With some embodiments of the apparatus, the first ML model is trained to infer the set of frames from the plurality of image frames.

With some embodiments of the apparatus, the first ML model is configured to receive as input one or more adjacent frames from the plurality of image frames.

With some embodiments of the apparatus, the first ML model is a convolutional neural network (CNN), a vision transformer network, or a combination of CNN and vision transformer networks and wherein the second ML model is a convolutional neural network (CNN), a vision transformer network, or a combination of CNN and vision transformer networks.

With some embodiments of the apparatus, the first ML model is configured apply a convolution window over a single frame or multiple adjacent frames from the plurality of image frames until all frames of the plurality of image frames have been received as input.

With some embodiments of the apparatus, the second ML model is trained to determine, for each frame of the plurality of image frames, whether the frame represents a side branch of the one or more side branches; and identify, for each frame determined to represent the side branch of the one or more side branches, the location in the frame of the side branch of the one or more side branches.

With some embodiments of the apparatus, the first ML model is configured to output, for each frame of the set of frames, a confidence score representing a confidence in the detection of the one or more side branches in the frame and wherein selecting a subset of frames from the set of frames comprises: identifying frames from the set of frames with a confidence score greater than or equal to a threshold level; and selecting the identified frames for inclusion in the subset of frames.

In some embodiments, the disclosure can be implemented as at least one machine readable storage device, comprising a plurality of instructions that in response to being executed by a processor of an intravascular ultrasound (IVUS) imaging system cause the processor to receive a series of IVUS images of a vessel of a patient, the series of IVUS images comprising a plurality of image frames; identify, via a first machine learning (ML) model, a set of frames of the plurality of image frames, wherein the frames of the set of frames are associated with one or more side branches of the vessel; identify, via a second ML model, a location of at least one of the one or more side branches in one or more frames of the plurality of image frames; select a subset of frames from the set of frames based in part on output from the first ML model and output from the second ML model.

With some embodiments of the at least one machine readable storage device, the plurality of instructions that in response to being executed by the processor of the IVUS imaging system further cause the processor to identifying adjacent frames from the plurality if image frames where the bounding boxes in each frame are within a threshold distance from each other; and merging the side branches associated with the identified frames.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates a IVUS imaging system, in accordance with at least one embodiment.

FIG. 2 illustrates an example vascular image.

FIG. 3A illustrates an example series of intravascular images.

FIG. 3B illustrates another example of the series of intravascular images.

FIG. 4 illustrates a combined internal and external vascular imaging system, in accordance with at least one embodiment.

FIG. 5 illustrates a side branch detection system, in accordance with at least one embodiment.

FIG. 6 illustrates a logic flow to detect side branches in a series of IVUS images, in accordance with at least one embodiment.

FIG. 7 illustrates another logic flow to detect side branches in a series of IVUS images, in accordance with at least one embodiment.

FIG. 8 illustrates a machine learning (ML) system suitable for use with at least one embodiment.

FIG. 9 illustrates a computer-readable storage medium, in accordance with at least one embodiment.

FIG. 10 illustrates a diagrammatic representation of a machine, in accordance with at least one embodiment.

### DETAILED DESCRIPTION

The foregoing has broadly outlined the features and technical advantages of the present disclosure such that the following detailed description of the disclosure may be better understood. It is to be appreciated by those skilled in the art that the embodiments disclosed may be readily utilized as a basis for modifying or designing other structures for carrying out the same purposes of the present disclosure. The novel features of the disclosure, both as to its organization and operation, together with further objects and advantages will be better understood from the following description when considered in connection with the accompanying figures. It is to be expressly understood, however, that each of the figures is provided for the purpose of illustration and description and is not intended as a definition of the limits of the present disclosure.

As noted above, the present disclosure relates to identifying side branches in a series of intravascular images (e.g., IVUS images) to assist with co-registering the intravascular images with either or both an extravascular image (e.g., an angiogram) or another set of intravascular images. As such, an example IVUS imaging system, patient vessel, series of IVUS images, and combined IVUS/external imaging system are described.

Suitable IVUS imaging systems include, but are not limited to, one or more transducers disposed on a distal end of a catheter configured and arranged for percutaneous insertion into a patient. Examples of IVUS imaging systems with catheters are found in, for example, U.S. Pat. Nos. 7,246,959; 7,306,561; and 6,945,938; as well as U.S. Patent Application Publication Numbers 2006/0100522; 2006/0106320; 2006/0173350; 2006/0253028; 2007/0016054; and 2007/0038111; all of which are incorporated herein by reference.

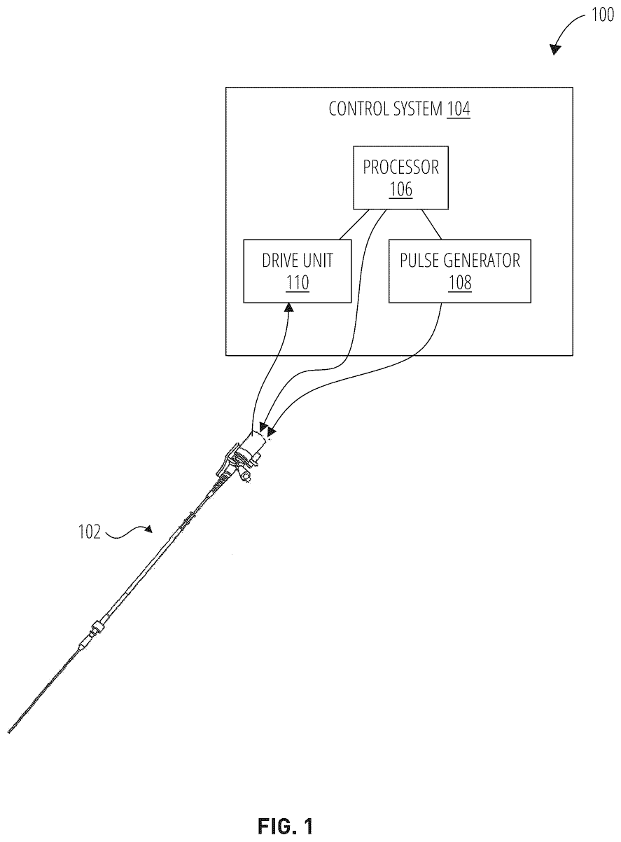

FIG. 1 illustrates schematically one embodiment of an IVUS imaging system 100. The IVUS imaging system 100 includes a catheter 102 that is couplable to a control system 104. The control system 104 may include, for example, a processor 106, a pulse generator 108, and a drive unit 110. In at least some embodiments, the pulse generator 108 forms electric pulses that may be input to one or more transducers (not shown) disposed in the catheter 102.

With some embodiments, mechanical energy from the drive unit 110 can be used to drive an imaging core (also not shown) disposed in the catheter 102. In at least some embodiments, electric signals transmitted from the one or more transducers may be input to the processor 106 for processing. In at least some embodiments, the processed electric signals from the one or more transducers can be used to form a series of images, described in more detail below. For example, a scan converter can be used to map scan line samples (e.g., radial scan line samples, or the like) to a two-dimensional Cartesian grid, which can be used as the basis for a series of IVUS images that can be displayed for a user.

In at least some embodiments, the processor 106 may also be used to control the functioning of one or more of the other components of the control system 104. For example, the processor 106 may be used to control at least one of the frequency or duration of the electrical pulses transmitted from the pulse generator 108, the rotation rate of the imaging core by the drive unit 110. Additionally, where IVUS imaging system 100 is configured for automatic pullback, the drive unit 110 can control the velocity and/or length of the pullback.

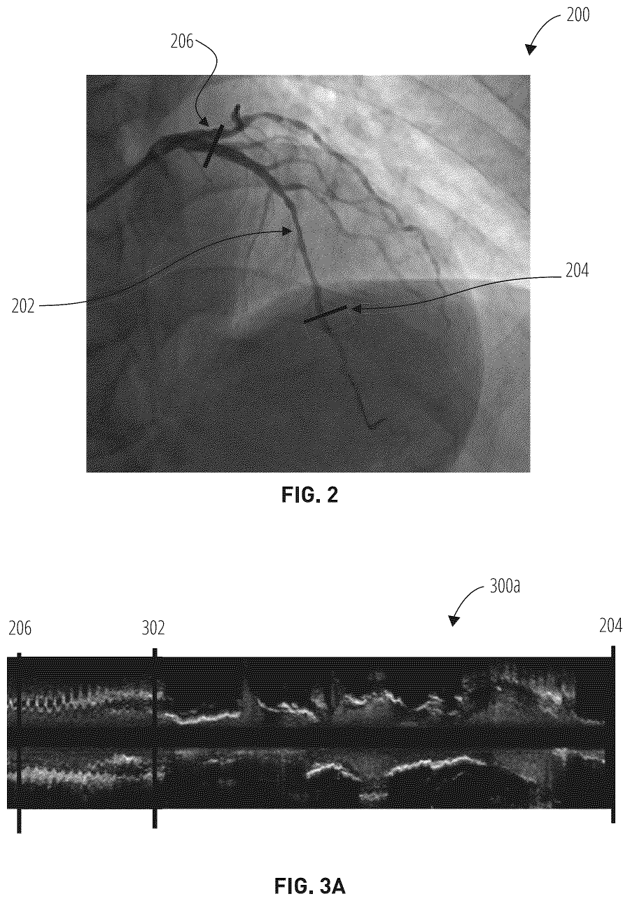

FIG. 2 illustrates an image 200 of a vessel 202 of a patient. As described, IVUS imaging systems (e.g., IVUS imaging system 100, or the like) are used to capture a series of images or a “recording” or a vessel, such as, vessel 202. For example, an IVUS catheter (e.g., catheter 102) is inserted into vessel 202 and a recording, or a series of IVUS images, is captured as the catheter 102 is pulled back from a distal end 204 to a proximal end 206. The catheter 102 can be pulled back manually or automatically (e.g., under control of drive unit 110, or the like).

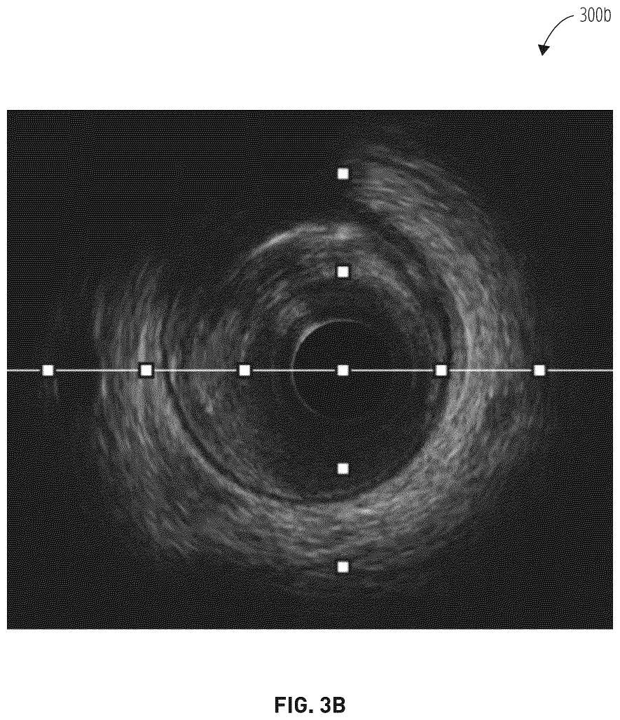

FIG. 3A and FIG. 3B illustrates two-dimensional (2D) representations of IVUS images of vessel 202. For example, FIG. 3A illustrates IVUS images 300a depicting a longitudinal view of the IVUS recording of vessel 202 between proximal end 206 and distal end 204.

FIG. 3B illustrates an image frame 300b depicting an on-axis (or short axis) view of vessel 202 at point 302. Said differently, image frame 300b is a single frame or single image from a series of IVUS images that can be captured between distal end 204 and proximal end 206 as described herein. As introduced above, the present disclosure provides systems and techniques to process raw IVUS images to identify side branches of the vessel and extract (or identify) frames from the IVUS images associated with the identified side branches to assist with co-registering the IVUS images with either or both an angiographic image or another set of IVUS images of the vessel.

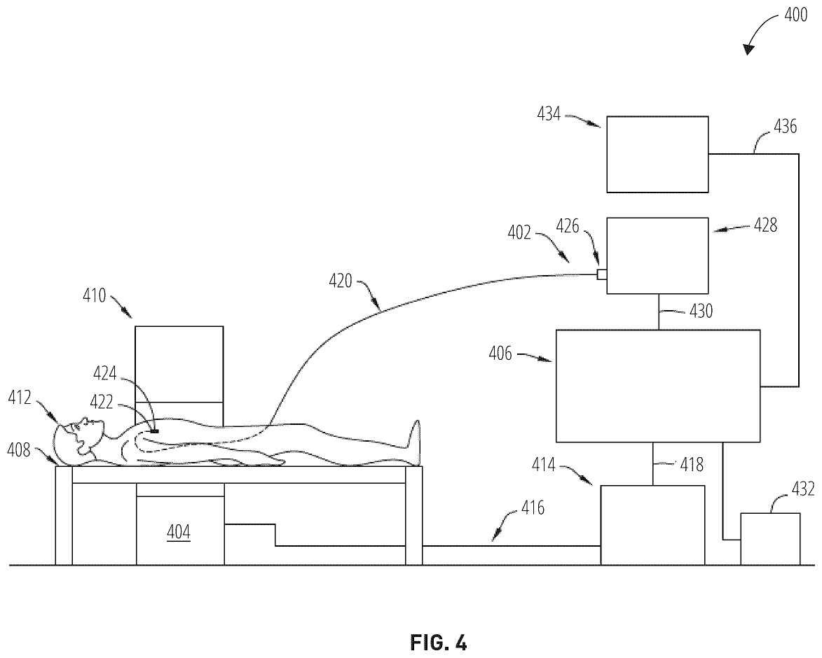

FIG. 4 illustrates a combined IVUS external imaging system 400 including both an IVUS imaging system 402 (e.g., IVUS imaging system 100, or the like) and an extravascular imaging system 404 (e.g., an angiographic imaging system). Combined IVUS external imaging system 400 further includes computing device 406, which includes circuitry, controllers, and/or processor(s) and memory and software configured to execute a method for vascular imaging registration of the obtained extravascular imaging data and the obtained intravascular imaging data. In general, the IVUS imaging system 402 can be arranged to generate IVUS intravascular imaging data (e.g., IVUS images 300a and image frame 300b) while the extravascular imaging system 404 can be arranged to generate extravascular imaging data (e.g., image 200).

The extravascular imaging system 404 may include an angiographic table 408 that may be arranged to provide sufficient space for the positioning of an angiography/fluoroscopy unit c-arm 410 in an operative position in relation to a patient 412 on the drive unit 110. Raw radiological image data acquired by the c-arm 410 may be passed to an extravascular data input port 414 via a transmission cable 416. The input port 414 may be a separate component or may be integrated into or be part of the computing device 406. The input port 414 may include a processor that converts the raw radiological image data received thereby into extravascular image data (e.g., angiographic/fluoroscopic image data), for example, in the form of live video, DICOM, or a series of individual images. The extravascular image data may be initially stored in memory within the input port 414 or may be stored within memory of computing device 406. If the input port 414 is a separate component from the computing device 406, the extravascular image data may be transferred to the computing device 406 through the transmission cable 418 and into an input port (not shown) of the computing device 406. In some alternatives, the communications between the devices or processors may be carried out via wireless communication, rather than by cables as depicted.

The intravascular imaging data may be, for example, IVUS data or OCT data obtained by the IVUS imaging system 402. The IVUS imaging system 402 may include an intravascular imaging device such as an imaging catheter 420. The imaging catheter 420 is configured to be inserted within the patient 412 so that its distal end, including a diagnostic assembly or probe 422 (e.g., an IVUS probe), is in the vicinity of a desired imaging location of a blood vessel. A radiopaque material or marker 424 located on or near the probe 422 may provide indicia of a current location of the probe 422 in a radiological image.

Imaging catheter 420 is coupled to a proximal connector 426 to couple imaging catheter 420 to image acquisition device 428. Image acquisition device 428 may be coupled to computing device 406 via transmission cable 430, or a wireless connection. The intravascular image data may be initially stored in memory within the image acquisition device 428 or may be stored within memory of computing device 406. If the image acquisition device 428 is a separate component from computing device 406, the intravascular image data may be transferred to the computing device 406, via, for example, transmission cable 430.

The computing device 406 can also include one or more additional output ports for transferring data to other devices. For example, the computer can include an output port to transfer data to a data archive or memory device 432. The computing device 406 can also include a user interface (described in greater detail below) that includes a combination of circuitry, processing components and instructions executable by the processing components and/or circuitry to enable dynamic co-registration of intravascular and extravascular images.

The user interface can be rendered and displayed on display 434 coupled to computing device 406 via display cable 436. Although the display 434 is depicted as separate from computing device 406, in some examples the display 434 can be part of computing device 406. Alternatively, the display 434 can be remote and wireless from computing device 406. As another example, the display 434 can be part of another computing device different from computing device 406, such as, a tablet computer, which can be coupled to computing device 406 via a wired or wireless connection.

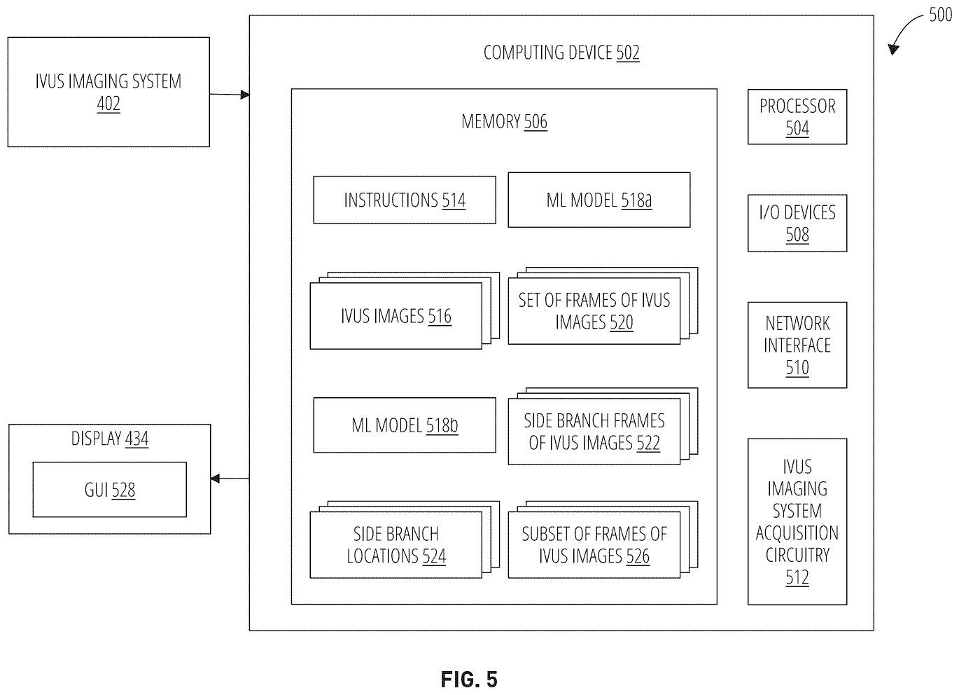

FIG. 5 illustrates a side branch detection system 500, according to some embodiments of the present disclosure. In general, side branch detection system 500 is a system for detecting side branches in a series of IVUS images using machine learning (ML) models to select a set of frames of the series of IVUS images representing side branches and an analytic algorithm to process and sub select from the set of frames, frames associated with “key” or “distinctive” side branches. The ML models can be trained using labelled IVUS images.

Side branch detection system 500 can be implemented in conjunction with a commercial IVUS guidance or navigation system, such as, for example, the AVVIGO® Guidance System available from Boston Scientific® and an external imaging system, such as, for example, the extravascular imaging system 404 described in conjunction with FIG. 4 above.

Side branch detection system 500 includes computing device 502. Computing device 502 can be any of a variety of computing devices. In some embodiments, computing device 502 can be incorporated into and/or implemented by computing device 406. With some embodiments, computing device 502 can be a workstation or server communicatively coupled to IVUS imaging system 100 and an external imaging system (e.g., extravascular imaging system 404, or the like). With still other embodiments, computing device 502 can be provided by a cloud based computing device, such as, by a computing as a service system accessibly over a network (e.g., the Internet, an intranet, a wide area network, or the like). Computing device 502 can include processor 504, memory 506, input and/or output (I/O) devices 508, network interface 510, and IVUS imaging system acquisition circuitry 512.

The processor 504 may include circuity or processor logic, such as, for example, any of a variety of commercial processors. In some examples, processor 504 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 504 may include graphics processing portions and may include dedicated memory, multiple-threaded processing and/or some other parallel processing capability. In some examples, the processor 504 may be an application specific integrated circuit (ASIC) or a field programmable integrated circuit (FPGA).

The memory 506 may include logic, a portion of which includes arrays of integrated circuits, forming non-volatile memory to persistently store data or a combination of non-volatile memory and volatile memory. It is to be appreciated, that the memory 506 may be based on any of a variety of technologies. In particular, the arrays of integrated circuits included in memory 120 may be arranged to form one or more types of memory, such as, for example, dynamic random access memory (DRAM), NAND memory, NOR memory, or the like.

I/O devices 508 can be any of a variety of devices to receive input and/or provide output. For example, I/O devices 508 can include, a keyboard, a mouse, a joystick, a foot pedal, a display, a touch enabled display, a haptic feedback device, an LED, or the like.

Network interface 510 can include logic and/or features to support a communication interface. For example, network interface 510 may include one or more interfaces that operate according to various communication protocols or standards to communicate over direct or network communication links. Direct communications may occur via use of communication protocols or standards described in one or more industry standards (including progenies and variants). For example, network interface 510 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 510 can include logic and/or features to enable communication over a variety of wired or wireless network standards (e.g., 704.11 communication standards). For example, network interface 510 may be arranged to support wired communication protocols or standards, such as, Ethernet, or the like. As another example, network interface 510 may be arranged to support wireless communication protocols or standards, such as, for example, Wi-Fi, Bluetooth, ZigBee, LTE, 5G, or the like.

The IVUS imaging system acquisition circuitry 512 may include circuity including custom manufactured or specially programmed circuitry configured to receive or receive and send signals between IVUS imaging system 100 including indications of an IVUS run, a series of IVUS images, or a frame or frames of IVUS images as well as to receive or receive and send signals between an external imaging system (e.g., an angiographic imaging system, extravascular imaging system 404, or the like).

Memory 506 can include instructions 514. During operation processor 504 can execute instructions 514 to cause computing device 502 to detect side branches in a series of IVUS images as outlined herein. For example, processor 504 can execute instructions 514 to receive IVUS images 516 from IVUS imaging system 402. In alternative embodiments, processor 504 can execute instructions 514 to receive IVUS images 516 from a memory device storing already captured IVUS images.

Processor 504 can execute instructions 514 and ML model 518a to generate the set of frames of IVUS images 520 from IVUS images 516 where set of frames of IVUS images 520 comprises frames of the frames of IVUS images 516 where a side branch is detected. With some embodiments, processor 504 can execute instructions 514 to derive set of frames of IVUS images 520 from ML model 518a using IVUS images 516 as inputs to ML model 518a. In some embodiments, ML model 518a can be a convolutional neural network (CNN) configured to take several frames (e.g., 2, 3, 4, etc.) at a time from IVUS images 516 and output an indication of a set of frames of the IVUS images 516 that depict or capture a side branch. In some embodiments, ML Model 518a can be a vision transformer or a combination of CNN and transformer network configured to take IVUS image 516 and output an indication of a set of frames of the IVUS images 516 that depict or capture side branches (e.g., set of frames of IVUS images 520, or the like).

Further, in some embodiments, processor 504 can execute instructions 514 to generate a side branch frames of IVUS images 522 from the set of frames of IVUS images 520 or IVUS imaged 516 where the side branch frames of IVUS images 522 comprises image frames (e.g., from the set of frames of IVUS images 520 or IVUS imaged 516) where a side branch is detected and a location on the frame where the side branch is detected. With some embodiments, processor 504 can execute instructions 514 to derive side branch frames of IVUS images 522 from ML model 518b using the set of frames of IVUS images 520 as inputs to ML model 518b. In other embodiments, processor 504 can execute instructions 514 to derive side branch frames of IVUS images 522 from ML model 518b using the IVUS images 516 as inputs to ML model 518b. In some embodiments, ML model 518b can be a CNN configured to take an IVUS frame or set of IVUS frames and (1) identify whether a side branch is represented in the frames and (2) generate location marker (e.g., bounding box, or the like) indicating an area of the frame where the side branch is identified. Further in some embodiments, ML Model 518b can be a vision transformer or a combination of CNN and transformer network configured to take an IVUS image frame or frames and (1) identify whether a side branch is represented in the frames and (2) generate location marker (e.g., bounding box or the like) indicating an area of the frame where the side branch is identified. The generated location markers can be stored in memory 506 as side branch locations 524.

In some embodiments, processor 504 can execute instructions 514 to analytically process the output of either or both ML model 518a and ML model 518b to generate a subset of frames of IVUS images 526. For example, processor 504 can execute instructions 514 to process the set of frames of IVUS images 520 and side branch frames of IVUS images 522 and the side branch locations 524 to determine the subset of frames of IVUS images 526 where the frames in the subset of frames of IVUS imaged 526 includes frames where the same side branch is indicated by both ML models 518a and 518b. As a specific example, processor 504 can execute instructions 514 to select the frame from set of frames of IVUS images 520 with the highest confidence of side branch detection based on the output from ML model 518a as the frame to include in the subset of frames of IVUS images 526.

As another example, processor 504 can execute instructions 514 to drop frames from side branch frames of IVUS images 522 where side branch locations 524 do not indicate a location of a side branch in the frame. Said differently, processor 504 can execute instructions 514 to exclude frames from the subset of frames of IVUS images 526 where a side branch locations 524 is not indicated for the frames in side branch frames of IVUS images 522.

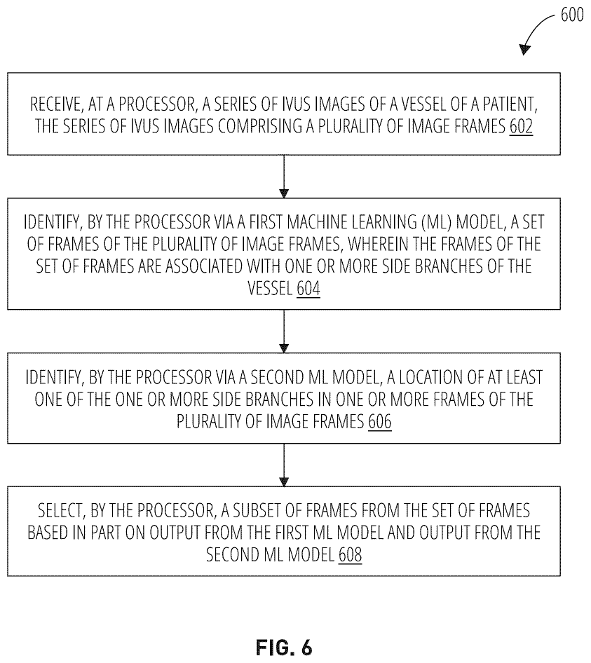

FIG. 6 illustrates the logic flow 600, which can be implemented to detect side branches in a series of IVUS images for purposes of co-registering the IVUS images with an angiogram or another series of IVUS images. The logic flow 600 can be implemented by side branch detection system 500 and will be described with reference to side branch detection system 500 for clarity of presentation. However, it is noted that logic flow 600 could also be implemented by an IVUS co-registration system different than side branch detection system 500.

Logic flow 600 can begin at block 602. At block 602 “receive, at a processor, a series of IVUS images of a vessel of a patient, the series of IVUS images comprising a plurality of image frames” a series of IVUS images can be received by a processor. For example, processor 504 can execute instructions 514 to receive IVUS images 516 (e.g., from IVUS imaging system 402, from a memory storage location, or the like). As detailed above, IVUS images 516 includes several frames of images from a “run” or pullback through a vessel.

Continuing to block 604 “identify, by the processor via a first machine learning (ML) model, a set of frames of the plurality of image frames, wherein the frames of the set of frames are associated with one or more side branches of the vessel” a set of frames of the plurality of image frames can be identified where the frames in the set of frames are associated with a side branch or side branches of the vessel. For example, processor 504 can execute instructions 514 to identify frames from IVUS images 516 where side branches are depicted or represented in the frame. More specifically, processor 504 can execute instructions 514 to derive the set of frames of IVUS images 520 from ML model 518a using IVUS images 516 as input. With some embodiments, ML model 518a can be configured to output set of frames of IVUS images 520 from IVUS images 516 as well as a confidence level for each frame in set of frames of IVUS images 520 where the confidence level comprising a level of confidence that the frame depicts or represents side branches.

Continuing to block 606 “identify, by the processor via a second ML model, a location of at least one of the one or more side branches in one or more frames of the plurality image frames” a location of at least one side branch of the one or more side branches in one or more frames of the plurality of image frames can be identified. For example, processor 504 can execute instructions 514 to identify a location of a side branch or side branches in a frame or frames of IVUS images 520 and store the location or locations as side branch locations 524. More specifically, processor 504 can execute instructions 514 to derive side branch frames of

IVUS images 522 and side branch locations 524 from ML model 518b using set of frames of IVUS images 520 as input. With some embodiments, ML model 518b can be configured to output an indication (e.g., bounding box, or the like) of a side branch locations 524 in each frame of set of frames of IVUS images 520 where a side branch is identified. Further, side branch frames of IVUS images 522 can be formed from the frames of IVUS images 520 where a location of side branches is identified by ML model 518b.

Continuing to block 608 “select, by the processor, s subset of frames from the set of frames based in part on output from the first ML model and output from the second ML model” a frame for each of one or more side branches can be selected from the series of IVUS images based on the set of frames and the location of the side branches in ones of the set of frames. For example, processor 504 can execute instructions 514 to determine a frame represents a side branch and include the frame in the subset of frames 526 if both the first ML model and the second ML model identify the frame as representing a side branch. In another example, processor 504 can execute instructions 514 to determine that multiple frames of the series of IVUS images 516 represents the same side branch based on side branch locations 524 and “merge” the frames or rather, select only one of the frames for inclusion in the subset of frames of IVUS images 526 based on the output from ML model 518a (e.g., confidence level above a threshold, or the like) and/or 518b (e.g., bounding box indicates same location, or the like).

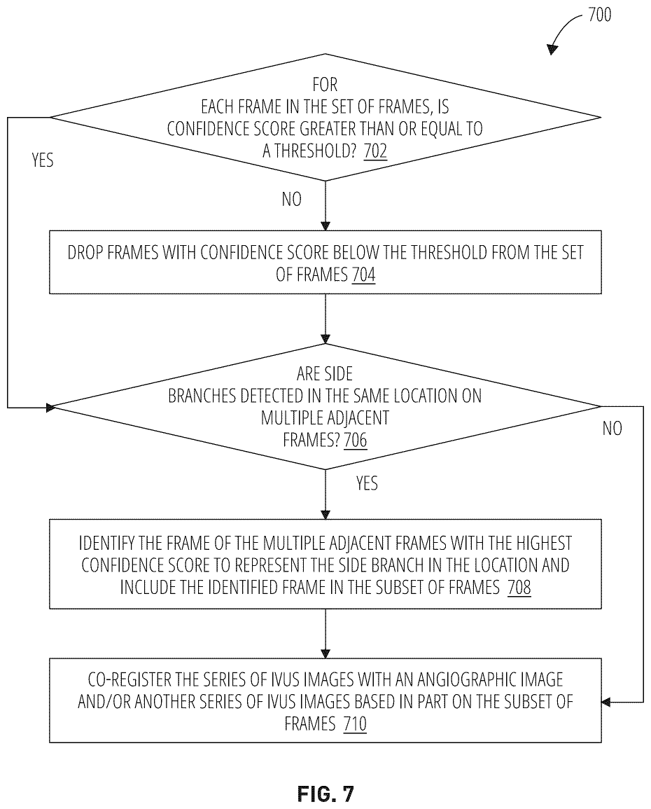

Logic flow 600 could further include blocks (see FIG. 7) to co-register the series of IVUS images received at block 602 with an angiogram of the vessel and/or with another series of IVUS images of the vessel. For example, processor 504 could execute instructions 514 to implement logic flow 600 to detect frames with side branches in a first series of IVUS images of a vessel captured pre-percutaneous intervention (PCI) treatment and to detect frames with side branches in a second series of IVUS images of the vessel captured post-PCI. Subsequently, processor 504 could execute instructions 514 to co-register the first series of IVUS images with the second series of IVUS images where the frames in each series corresponding to side branches are used to facilitate the co-registration.

FIG. 7 illustrates the logic flow 700, which can be implemented to select frames from a series of IVUS images representing side branches based on a set (or subset) of frames identified as representing side branches using an ML model. For example, logic flow 700 could be implemented at block 608 of logic flow 600. The logic flow 700 can be implemented by side branch detection system 500 and will be described with reference to side branch detection system 500 for clarity of presentation. However, it is noted that logic flow 700 could also be implemented by an IVUS co-registration system different than side branch detection system 500.

Logic flow 700 could begin at decision block 702. At decision block 702 “for each frame in the set of frames, is confidence score greater than or equal to a threshold?” a determination as to whether the confidence of side branch detection for each frame in the set of frames can be determined. For example, a detailed above processor 504 can execute instructions 514 to derive set of frames of IVUS images 520 from ML model 518a using IVUS images 516 as inputs. In addition to inferring set of frames of IVUS images 520 from IVUS images 516, ML model 518a can output a level of confidence, for each frame in set of frames of IVUS images 520, that the detected side branch is an actual side branch. Said differently, the ML model 518a can output a confidence score or measure that the inference is accurate. At decision block 702, processor 504 can execute instructions 514 to determine whether the confidence score for each frame is above (e.g., greater than or equal to) a threshold level.

From decision block 702, logic flow 700 can continue to either block 704 or decision block 706. For example, logic flow 700 can continue from decision block 702 to block 704 based on a determination that the confidence score for frames in the set of frames is not higher than a threshold level while logic flow 700 can continue from decision block 702 to decision block 706 based on a determination that the confidence score for frames in the set of frames is higher than a threshold level. At block 704 “drop frames with confidence score below the threshold from the set of frames” frames with a confidence score below the threshold can be dropped from the set of frames. In some embodiments, decision block 702 and block 704 can be performed iteratively on a frame by frame basis. At block 704, processor 504 can execute instructions 514 to form the subset of frames of IVUS images 526 from the set of frames of IVUS images 520 by only including frames from set of frames of IVUS images 520 in the subset of frames of IVUS images 526 where the frames have a confidence score above the threshold level.

At decision block 706 “are side branches detected in the same location on multiple adjacent frames?” a determination as to whether side branches are detected in the same location on multiple adjacent frames can be made. For example, processor 504 can execute instructions 514 to determine whether the side branch locations 524 for multiple frames that are adjacent to each other (e.g., side by side, within a set number of frames, within a set distance, or the like). As a specific example, processor 504 can execute instructions 514 to determine whether the side branch locations 524 for frames in the subset of frames of IVUS images 522 located within a specified distance (e.g., less than or equal to ⅓ of a millimeter, or the like) is the same.

From decision block 706, logic flow 700 can continue to either block 708 or block 710. For example, logic flow 700 can continue from decision block 706 to block 708 based on a determination that side branches are detected in the same location on multiple adjacent frames while logic flow 700 can continue from decision block 706 to block 710 based on a determination that side branches are not detected in the same location on multiple adjacent frames.

At block 708 “identify the frame of the multiple adjacent frames with the highest confidence score to represent the side branch in the location and include the identified frame in the subset of frames” a single frame from the adjacent frames having the same side branch location (e.g., based on the side branch location 524, or the like) can be selected to represent the side branch. For example, processor 504 can execute instructions 514 to select a single frame from a group of adjacent frames (e.g., frames located within a specified distance of each other, or the like) identified at decision block 706 as having the same side branch location to include in subset of frames of IVUS images 526. With some embodiments, processor 504 can execute instructions 514 to select the frame having the highest confidence score output from ML model 518a as the frame to include in the subset of frames of IVUS images 526.

At block 710 “co-register the series of IVUS images with an angiographic image and/or another series of IVUS images based on the ones of the set of frames” the ones of the set of frames can be used to co-register the series of IVUS images with an angiogram or another series of IVUS images of the vessel as outlined above. For example, processor 504 could execute instructions 514 to implement logic flow 600 to detect frames with side branches in a first series of IVUS images of a vessel captured pre-PCI treatment and to detect frames with side branches in a second series of IVUS images of the vessel captured post-PCI. Subsequently, processor 504 could execute instructions 514 to co-register the first series of IVUS images with the second series of IVUS images where the frames in each series corresponding to side branches are used to facilitate the co-registration.

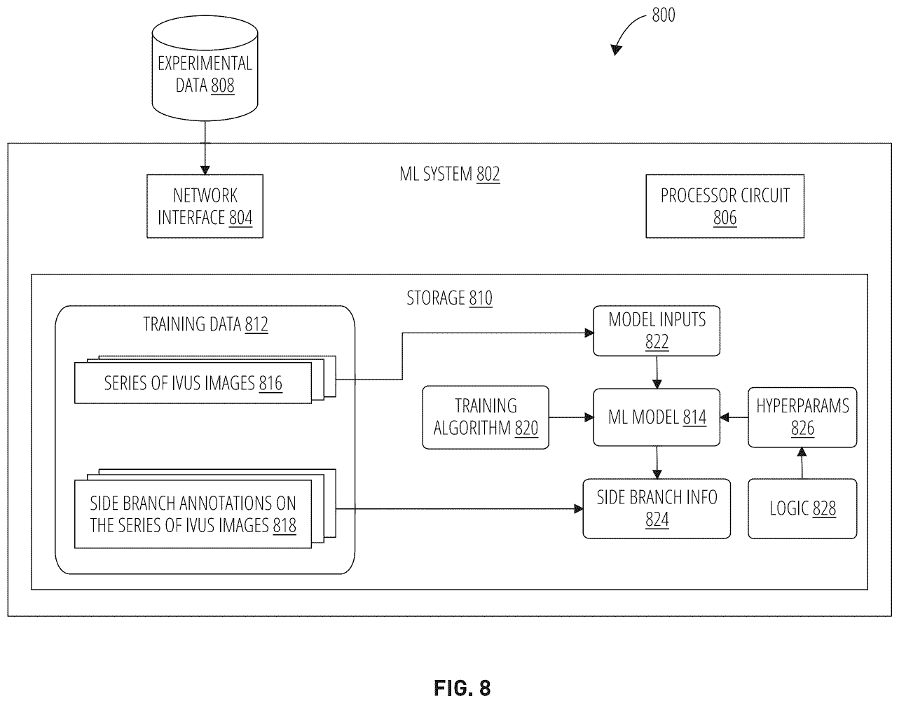

As noted, with some embodiments, processor 504 of computing device 502 can execute instructions 514 to generate set of frames of IVUS images 520, side branch frames of IVUS images 522, and/or side branch locations 524 using an ML model or models. In such example, the ML model can be stored in memory 506 of computing device 502. It will be appreciated, that prior to being deployed, the ML model is to be trained. FIG. 8 illustrates an ML environment 800, which can be used to train an ML model that may later be used to generate (or infer) set of frames of IVUS images 520 and/or subset of frames of IVUS images 522 as described herein. The ML environment 800 may include an ML system 802, such as a computing device that applies an ML algorithm to learn relationships. In this example, the ML algorithm can learn relationships between a set of inputs (e.g., series of IVUS images 816) and a set of outputs (e.g., side branch annotations on the series of IVUS images 818) to be able to infer (e.g., during deployment or the like) outputs (e.g., set of frames of IVUS images 520, side branch frames of IVUS images 522, side branch locations 524) from unseen or new inputs (e.g., IVUS images 516, set of frames of IVUS images 520, or the like).

The ML system 802 may make use of experimental data 808 gathered during several prior procedures. Experimental data 808 can include a series of IVUS images 816 for several patients. The experimental data 808 may be collocated with the ML system 802 (e.g., stored in a storage 810 of the ML system 802), may be remote from the ML system 802 and accessed via a network interface 804, or may be a combination of local and remote data.

Experimental data 808 can be used to form training data 812. As noted above, the ML system 802 may include a storage 810, which may include a hard drive, solid state storage, and/or random access memory. The storage 810 may hold training data 812. In general, training data 812 can include information elements or data structures comprising indications of a series of IVUS images 816 for several patients. In addition, training data 812 can optionally include side branch annotations on the series of IVUS images 818. For example, side branch annotations on the series of IVUS images 818 can comprise series of IVUS images 816 annotated to indicate frames that depict or represent a side branch.

The training data 812 may be applied to train an ML model 814. Depending on the application, different types of models may be used to form the basis of ML model 814. For instance, in the present example, an artificial neural network (ANN) such as CNNs and/or vision transformers may be particularly well-suited to learning associations between a series of IVUS images (e.g., series of IVUS images 816) and side branches depicted or represented in the series (e.g., frames with a side branch, side branch locations in the frame, etc.)

Any suitable training algorithm 820 may be used to train the ML model 814. Nonetheless, the example depicted in FIG. 8 may be particularly well-suited to a supervised training algorithm or reinforcement learning training algorithm. For a supervised training algorithm, the ML system 802 may apply the series of IVUS images 816 as model inputs 822, to which side branch annotations on the series of IVUS images 818 may be mapped to learn associations between the model inputs 822 and the side branch info 824 (e.g., frames representing a side branch, a bounding box around a side branch location, etc.) output by the ML model 814. In a reinforcement learning scenario, training algorithm 820 may attempt to maximize some or all (or a weighted combination) of the model inputs 822 mappings to side branch info 824 to produce ML model 814 having the least error. With some embodiments, training data 812 can be split into “training” and “testing” data wherein some subset of the training data 812 can be used to adjust the ML model 814 (e.g., internal weights of the model, or the like) while another, non-overlapping subset of the training data 812 can be used to measure an accuracy of the ML model 814 to infer (or generalize) a side branch info 824 from “unseen” training data 812 (e.g., training data 812 not used to train ML model 814).

The ML model 814 may be applied using a processor circuit 806, which may include suitable hardware processing resources that operate on the logic and structures in the storage 810. The training algorithm 820 and/or the development of the trained ML model 814 may be at least partially dependent on hyperparameters 826. In exemplary embodiments, the model hyperparameters 826 may be automatically selected based on hyperparameter optimization logic 828, which may include any known hyperparameter optimization techniques as appropriate to the ML model 814 selected and the training algorithm 820 to be used. In optional, embodiments, the ML model 814 may be re-trained over time, to accommodate new knowledge and/or updated experimental data 808.

Once the ML model 814 is trained, it may be applied (e.g., by the processor circuit 806, by processor 504, or the like) to new input data (e.g., IVUS images 516, or the like). This input to the ML model 814 may be formatted according to a predefined model inputs 822 mirroring the way that the training data 812 was provided to the ML model 814. The ML model 814 may generate a side branch info 824 which may be, for example, a set of frames of IVUS images 520 where side branches are detected, a side branch locations 524 in the frames where side branches are located, or the like.

The above description pertains to a particular kind of ML system 802, which applies supervised learning techniques given available training data with input/result pairs. However, the present invention is not limited to use with a specific ML paradigm, and other types of ML techniques may be used. For example, in some embodiments the ML system 802 may apply for example, evolutionary algorithms, or other types of ML algorithms and models to generate side branch info 824 from series of IVUS images 816. For example, user interactions with the outputs (e.g., deleting identified side branches, or the like) can be logged and such logged information can be used to retrain ML model 814.

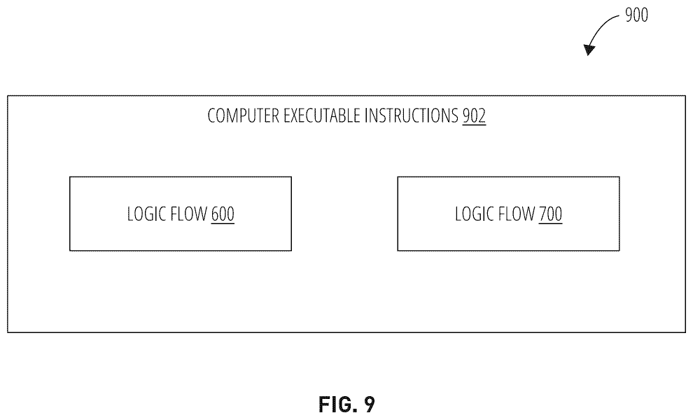

FIG. 9 illustrates computer-readable storage medium 900. Computer-readable storage medium 900 may comprise any non-transitory computer-readable storage medium or machine-readable storage medium, such as an optical, magnetic or semiconductor storage medium. In various embodiments, computer-readable storage medium 900 may comprise an article of manufacture. In some embodiments, computer-readable storage medium 900 may store computer executable instructions 902 with which circuitry (e.g., processor 106, processor 504, IVUS imaging system acquisition circuitry 512, and the like) can execute. For example, computer executable instructions 902 can include instructions to implement operations described with respect to logic flow 600 and/or logic flow 700. Examples of computer-readable storage medium 900 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 902 may include any suitable type of code, such as source code, compiled code, interpreted code, executable code, static code, dynamic code, object-oriented code, visual code, and the like.

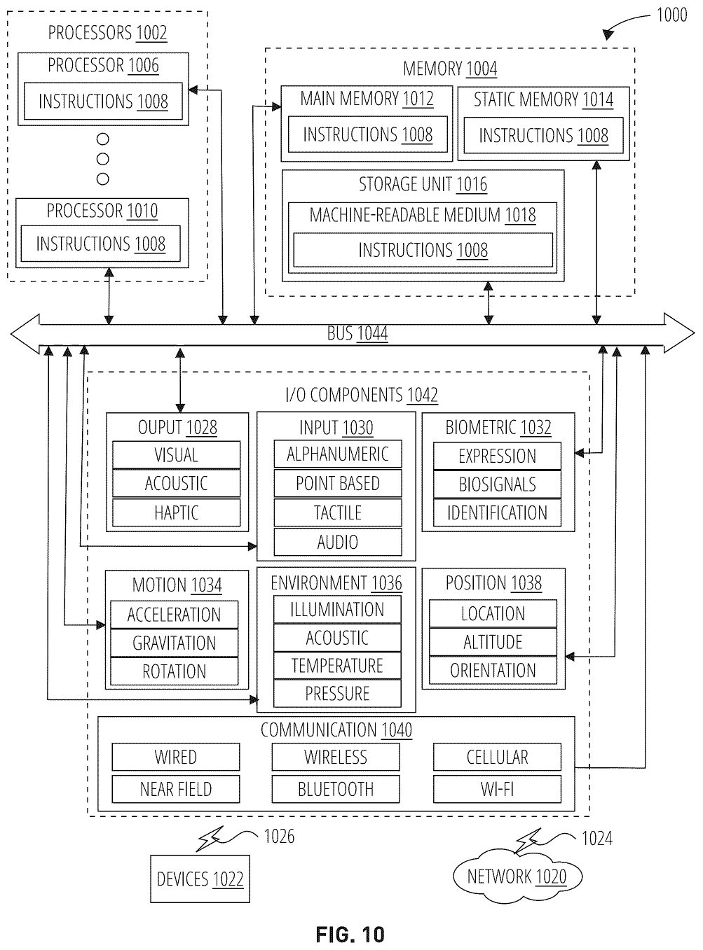

FIG. 10 illustrates a diagrammatic representation of a machine 1000 in the form of a computer system within which a set of instructions may be executed for causing the machine to perform any one or more of the methodologies discussed herein. More specifically, FIG. 10 shows a diagrammatic representation of the machine 1000 in the example form of a computer system, within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute logic flow 600 of FIG. 6, logic flow 700 of FIG. 7, or the like. More generally, the instructions 1008 may cause the machine 1000 to detect side branches in a series of IVUS images to co-register the IVUS images with either or both of an angiogram and another series of IVUS images.

The instructions 1008 transform the general, non-programmed machine 1000 into a particular machine 1000 programmed to carry out the described and illustrated functions in a specific manner. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while a single machine 1000 is illustrated, the term “machine” shall also be taken to include a collection of machines 1000 that individually or jointly execute the instructions 1008 to perform any one or more of the methodologies discussed herein.

The machine 1000 may include processors 1002, memory 1004, and I/O components 1042, which may be configured to communicate with each other such as via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that may execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 may include a main memory 1012, a static memory 1014, and a storage unit 1016, both accessible to the processors 1002 such as via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones will likely include a touch input device or other such input mechanisms, while a headless server machine will likely not include such a touch input device. It will be appreciated that the I/O components 1042 may include many other components that are not shown in FIG. 10. The I/O components 1042 are grouped according to functionality merely for simplifying the following discussion and the grouping is in no way limiting. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 may include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (i.e., memory 1004, main memory 1012, static memory 1014, and/or memory of the processors 1002) and/or storage unit 1016 may store one or more sets of instructions and data structures (e.g., software) embodying or utilized by any one or more of the methodologies or functions described herein. These instructions (e.g., the instructions 1008), when executed by processors 1002, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1020 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1020 or a portion of the network 1020 may include a wireless or cellular network, and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1008 may be transmitted or received over the network 1020 using a transmission medium via a network interface device (e.g., a network interface component included in the communication components 1040) and utilizing any one of several well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022. The terms “transmission medium” and “signal medium” mean the same thing and may be used interchangeably in this disclosure. The terms “transmission medium” and “signal medium” shall be taken to include any intangible medium that can store, encoding, or carrying the instructions 1008 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

By using genuine models of anatomy more accurate surgical plans may be developed than through statistical modeling.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. A method, comprising:
receiving, at a processor, a series of intravascular ultrasound (IVUS) images of a vessel of a patient, the series of IVUS images comprising a plurality of frames;
identifying, by the processor via a first machine learning (ML) model, a set of frames of the plurality of image frames, wherein frames of the set of frames are associated with one or more side branches of the vessel;
identifying, by the processor via a second ML model, a location of at least one of the one or more side branches in one or more frames of the plurality of image frames;
selecting, by the processor, a subset of frames from the set of frames based in part on output from the first ML model and output from the second ML model.

2. The method of claim 1, wherein the first ML model is trained to infer the set of frames from the plurality of image frames.

3. The method of claim 1, wherein the first ML model is configured to receive as input one or more adjacent frames from the plurality of image frames.

4. The method of claim 1, wherein the first ML model is a convolutional neural network (CNN), a vision transformer network, or a combination of CNN and vision transformer networks.

5. The method of claim 4, wherein the first ML model is configured apply a convolution window over a single frame or multiple adjacent frames from the plurality of image frames until all frames of the plurality of image frames have been received as input.

6. The method of claim 1, wherein the second ML model is trained to:
Determine, for each frame of the plurality of image frames, whether the frame represents a side branch if the one or more side branches; and
identify, for each frame determined to represent the side branch of the one or more side branches, the location in the frame of the side branch of the one or more side branches.

7. The method of claim 1, wherein the first ML model is configured to output, for each frame of the set of frames, a confidence score representing a confidence in the detection of the one or more side branches in the frame and wherein selecting a subset of frames from the set of frames comprises:
identifying frames from the set of frames with a confidence score greater than or equal to a threshold level; and
selecting the identified frames for inclusion in the subset of frames.

8. The method of claim 1, wherein the second ML model is trained to generate an indication of the location as a bounding box.

9. The method of claim 8, wherein selecting frames from the ones of the set of frames of the series of IVUS images comprises:
identifying adjacent frames from the plurality of image frames where the bounding boxes in each frame are within a threshold distance from each other; and
merging the side branches associated with the identified frames.

10. The method of claim 9, wherein the first ML model is configured to output, for each frame of the set of frames, a confidence score representing a confidence in the detection of the one or more side branches in the frame and wherein merging the side branches associated with the identified adjacent frames comprises:
identifying the one of the adjacent frames from the set of frames where the bounding boxes are within a threshold distance of each other with the highest confidence score; and
selecting the identified one of the adjacent frames with the highest confidence score as the frame from the plurality of image frames for inclusion in the subset of frames.

11. The method of claim 1, wherein the second ML model is a convolutional neural network (CNN), a vision transformer network, or a combination of CNN and vision transformer networks.

12. An apparatus for an intravascular imaging device, comprising:
a processor; and
a memory comprising instructions that in response to being executed by the processor cause the apparatus to:
receive a series of intravascular ultrasound (IVUS) images of a vessel of a patient, the series of IVUS images comprising a plurality of image frames;
identify, via a first machine learning (ML) model, a set of frames of the plurality of image frames, wherein the frames of the set of frames are associated with one or more side branches of the vessel;
identify, via a second ML model, a location of at least one of the one or more side branches in one or more frames of the plurality of image frames;
select a subset of frames from the set of frames based in part on output from the first ML model and output from the second ML model.

13. The apparatus of claim 12, wherein the first ML model is trained to infer the set of frames from the plurality of image frames.

14. The method of claim 12, wherein the first ML model is configured to receive as input one or more adjacent frames from the plurality of image frames.

15. The apparatus of claim 12, wherein the first ML model is a convolutional neural network (CNN), a vision transformer network, or a combination of CNN and vision transformer networks and wherein the second ML model is a convolutional neural network (CNN), a vision transformer network, or a combination of CNN and vision transformer networks.

16. The apparatus of claim 15, wherein the first ML model is configured apply a convolution window over a single frame or multiple adjacent frames from the plurality of image frames until all frames of the plurality of image frames have been received as input.

17. The apparatus of claim 12, wherein the second ML model is trained to:
Determine, for each frame of the plurality of image frames, whether the frame represents a side branch of the one or more side branches; and
identify, for each frame determined to represent the side branch of the one or more side branches, the location in the frame of the side branch of the one or more side branches.

18. The apparatus of claim 12, wherein the first ML model is configured to output, for each frame of the set of frames, a confidence score representing a confidence in the detection of the one or more side branches in the frame and wherein selecting a subset of frames from the set of frames comprises:
identifying frames from the set of frames with a confidence score greater than or equal to a threshold level; and
selecting the identified frames for inclusion in the subset of frames.

19. At least one machine readable storage device, comprising a plurality of instructions that in response to being executed by a processor of an intravascular ultrasound (IVUS) imaging system cause the processor to:
receive a series of IVUS images of a vessel of a patient, the series of IVUS images comprising a plurality of image frames;
identify, via a first machine learning (ML) model, a set of frames of the plurality of image frames, wherein the frames of the set of frames are associated with one or more side branches of the vessel;
identify, via a second ML model, a location of at least one of the one or more side branches in one or more frames of the plurality of image frames;
select a subset of frames from the set of frames based in part on output from the first ML model and output from the second ML model.

20. The at least one machine readable storage device of claim 19, the plurality of instructions that in response to being executed by the processor of the IVUS imaging system cause the processor to:
identify adjacent frames from the plurality if image frames where the bounding boxes in each frame are within a threshold distance from each other; and
merging the side branches associated with the identified frames.
